(19) United States
(12) Patent Application Publication
(10) Pub. No.: US 2025/0007119 A1
(43) Pub. Date: Jan. 2, 2025

(54) LASER WELDED INTERNAL TERMINALS FOR BATTERY CELLS

(71) Applicant: GM GLOBAL TECHNOLOGY OPERATIONS LLC, Detroit, MI (US)

(72) Inventors: Teresa Jean RINKER, Royal Oak, MI (US); Masoud MOHAMMADPOUR, Novi, MI (US); Junjie MA, Novi, MI (US); Blair E. CARLSON, Ann Arbor, MI (US); Jennifer Therese BRACEY, Holly, MI (US)

(21) Appl. No.: 18/342,095

(22) Filed: Jun. 27, 2023

(51) Int. Cl. H01M 50/536; H01M 50/533; H01M 50/54

(52) U.S. Cl. CPC H01M 50/536; H01M 50/533; H01M 50/54

(57) ABSTRACT

A battery cell includes a stack including C cathode electrodes, A anode electrodes, and S separators, where C, A and S are integers greater than one. A first internal terminal includes a first slot. The external tabs of one of the C cathode electrodes and the A anode electrodes are inserted into the first slot. One of edges of the external tabs of one of the C cathode electrodes and the A anode electrodes are laser welded in the first slot, and portions of the external tabs of the one of the C cathode electrodes and the A anode electrodes extend through the first slot, are folded and laser welded to a surface of the first internal terminal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to laser welded internal terminals for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, and S separators, where C, A and S are integers greater than one. A first internal terminal includes a first slot. The external tabs of one of the C cathode electrodes and the A anode electrodes are inserted into the first slot. Portions of the external tabs of the one of the C cathode electrodes and the A anode electrodes extend through the first slot, are folded and laser welded to a surface of the first internal terminal.

In other features, a second internal terminal including a second slot to receive the external tabs of the other one of the C cathode electrodes and the A anode electrodes.

In other features, portions of the external tabs of the other one of the C cathode electrodes and the A anode electrodes extending through the second slot are folded and laser welded to a surface of the second internal terminal.

In other features, the first internal terminal includes N of the first slot, where N is an integer greater than one. The external tabs of the one of the C cathode electrodes and the A anode electrodes are divided into N groups that are inserted through the N first slots, respectively, and are folded and laser welded to a surface of the first internal terminal.

In other features, the N first slots are open-ended. The first slot is open-ended. The external tabs of the one of the C cathode electrodes and the A anode electrodes are separated into a first group and a second group, folded in first and second directions, respectively, and laser welded to a surface of the first internal terminal on opposite sides of the first slot. The first internal terminal is “L”-shaped and includes a first portion and a second portion extending transversely relative to the first portion.

In other features, the battery cell includes an enclosure, a first external terminal in contact with the first internal terminal, and a second external terminal in contact with the second internal terminal.

A battery cell includes a stack including C cathode electrodes each including a cathode current collector, a cathode active layer arranged on the cathode current collector, and an external tab extending from the cathode current collector, A anode electrodes including an anode current collector, an anode active layer arranged on the anode current collector, and an external tab extending from the anode current collector, and S separators, where C, A and S are integers greater than zero.

A first internal terminal includes R slots, where R is an integer greater than zero. The external tabs of the one of the C cathode electrodes and the A anode electrodes are folded and laser welded to an inner surface of the first internal terminal through at least one of the R slots of the first internal terminal.

In other features, a second internal terminal includes R slots. The external tabs of the other one of the C cathode electrodes and the A anode electrodes are folded and laser welded to an inner surface of the second internal terminal through at least one of the R slots of the second internal terminal.

In other features, R is greater than one. The external tabs of the one of the C cathode electrodes and the A anode electrodes are folded and laser welded to an inner surface of the first internal terminal through at least another one of the R slots of the first internal terminal. The first internal terminal has an “L”-shape and includes a first portion and a second portion extending transversely relative to the first portion.

In other features, the external tabs of the one of the C cathode electrodes and the A anode electrodes include first external tabs and second external tabs that are folded in first and second directions and laser welded to the inner surface of the first internal terminal through the at least one of the R slots of the first internal terminal.

In other features, the battery cell includes an enclosure, a first external terminal in contact with the first internal terminal, and a second external terminal in contact with the second internal terminal.

A battery cell includes a stack including C cathode electrodes each including a cathode current collector, a cathode active layer arranged on the cathode current collector, and an external tab extending from the cathode current collector, A anode electrodes including a cathode current collector, a cathode active layer arranged on the cathode current collector, and an external tab extending from the cathode current collector, and S separators, where C, A and S are integers greater than one. A first internal terminal includes a planar portion and a second portion including a center portion connected to the second portion and first and second side walls extending from the center portion. The external tabs of the one of the C cathode electrodes and the A anode electrodes pass through the first and second side walls of the first internal terminal and are laser welded to an inner surface of the first and second side walls of the first internal terminal.

In other features, a second internal terminal includes a planar portion and a second portion including a center portion and first and second sides extending from the center portion. The external tabs of the other one of the C cathode electrodes and the A anode electrodes pass through the first and second sides and are laser welded to an inner surface of the first and second side walls of the second internal terminal.

In other features, the battery cell includes an enclosure, a first external terminal in contact with the planar portion of the first internal terminal, and a second external terminal in contact with the planar portion of the second internal terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell;

FIG. 2 is a perspective view of an example of a prismatic battery cell including laser welded internal terminals that are in contact with external terminals according to the present disclosure;

FIG. 3 is a perspective view of an example of a prismatic battery cell including electrodes with external tabs that are laser welded to the internal terminals;

FIG. 4 is a perspective view illustrating laser welding of the external tabs of electrodes to an inner surface of an internal terminal;

FIGS. 5A to 5D are perspective views illustrating examples of internal terminals with one or more slots and external tabs of electrodes laser welded to the internal terminals in or through the one or more slots according to the present disclosure;

FIGS. 6A to 6D are perspective views illustrating examples of internal terminals with one or more open-ended slots and external tabs of electrodes laser welded to the internal terminals through the one or more open-ended slots according to the present disclosure;

FIGS. 7A and 7B are perspective views of another example of internal terminals laser welded to external tabs of electrodes according to the present disclosure; and

FIGS. 8A and 8B are perspective views of an example of internal terminals with slots and external tabs of electrodes laser welded to an inner surface of the internal terminals through the slots according to the present disclosure.

In the drawings, reference numbers may be reused to identify similar and/or identical elements.

### DETAILED DESCRIPTION

While battery cells including laser welded internal terminals according to the present disclosure are shown in the context of electric vehicles, the battery cells including laser welded internal terminals can be used in stationary applications and/or other applications.

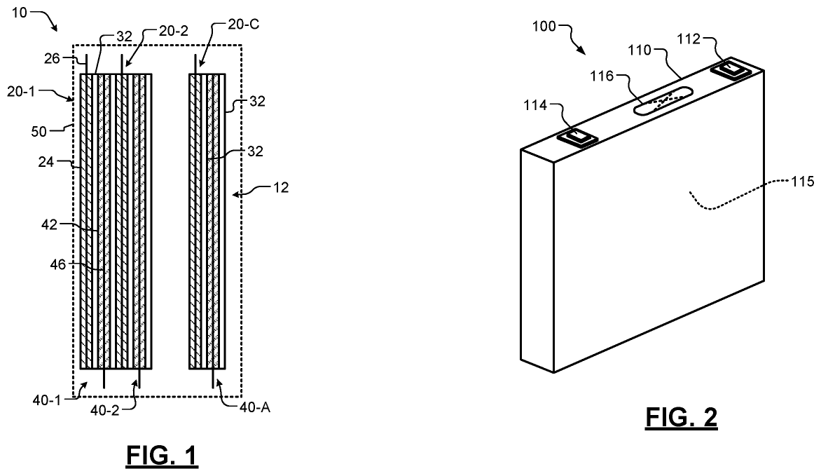

Referring now to FIG. 1, a battery cell 10 includes C cathode electrodes 20, A anode electrodes 40, and S separators 32 arranged in a predetermined sequence in a stack 12 in an enclosure 50, where C, A and S are integers greater than one. In some examples, A=C+1. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

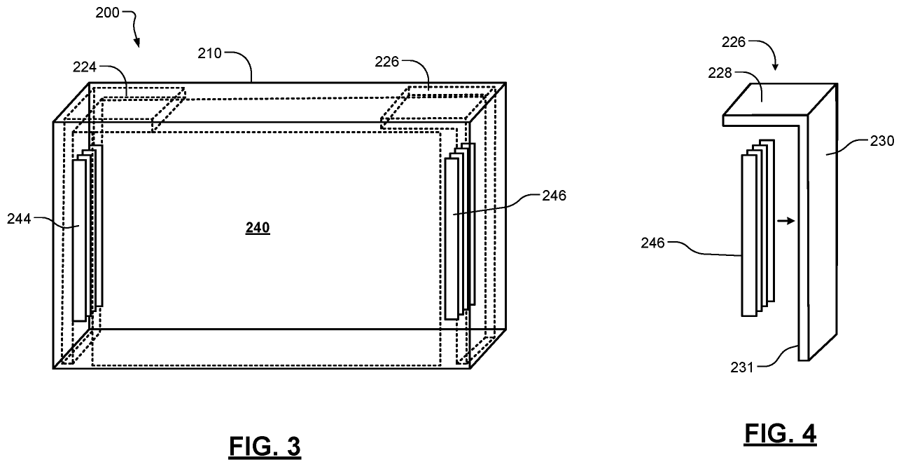

Referring now to FIG. 2, a prismatic battery cell 100 includes an enclosure 110. In some examples, the enclosure 110 has a rectangular cross-section. The prismatic battery cell 100 includes external terminals 112 and 114 and a vent cap 116. A stack 115 of the C cathode electrodes 20, the A anode electrodes 40, and the S separators 32 is arranged in the enclosure 110. As will be described further below, the anode current collectors 46 and/or the cathode current collectors 26 include external tabs that are laser welded to internal terminals contacting the external terminals 112 and 114 of the battery cell 10.

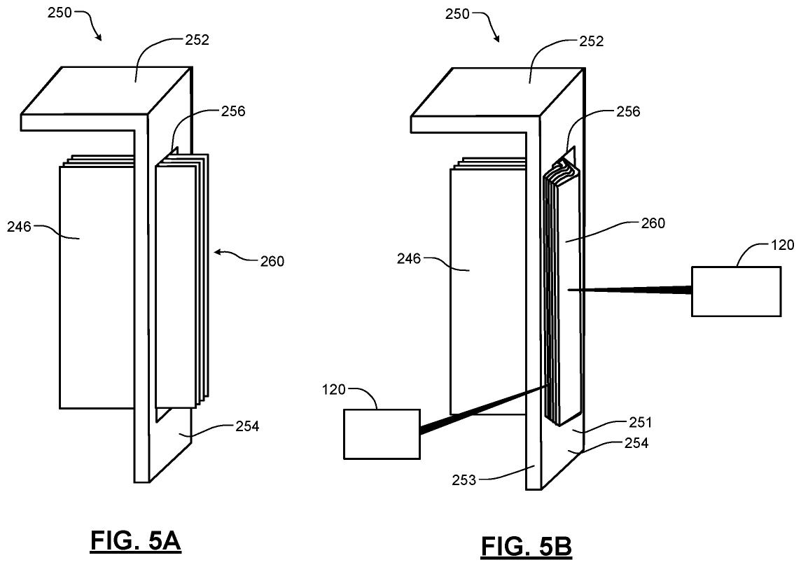

Referring now to FIG. 3, a prismatic battery cell 200 includes an enclosure 210 and internal terminals 224 and 226 arranged at opposite ends of the enclosure 210. A stack 240 of the C cathode electrodes, the A anode electrodes, and the S separators is arranged in the enclosure 210. The anode current collectors and/or the cathode current collectors include external tabs 244 and 246 that extend therefrom, respectively. The external tabs 244 and 246 are laser welded to inner surfaces of the internal terminals 224 and 226, respectively.

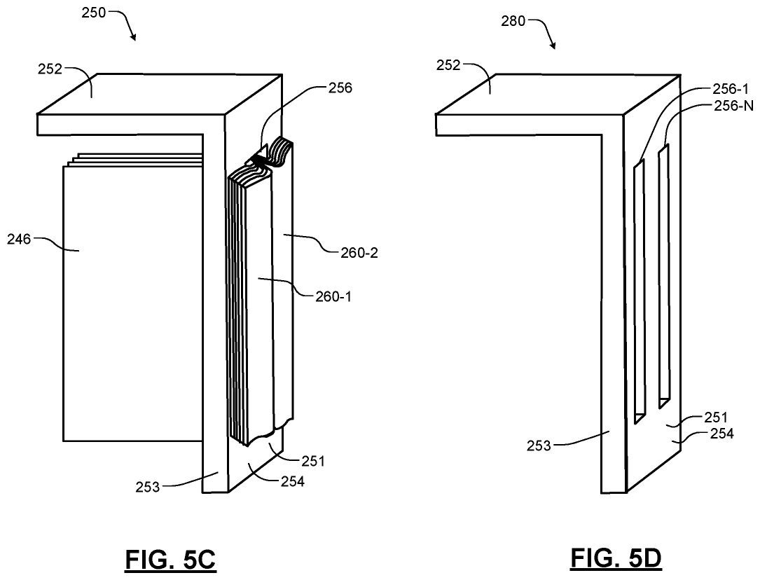

In FIG. 4, the internal terminal 226 includes a first portion 228 and a second portion 230 extending from the first portion 228. In some examples, the first portion 228 is “L”-shaped and forms an angle in a range from 80° to 100° (e.g., 90°) relative to the second portion 230. In some examples, the external tabs 246 are laser welded to an inner surface 231 of the internal terminal 226, respectively. Laser welding the external tabs 244 and 246 using this approach is difficult. The internal terminal 226 contacts one of the external terminals 112 and 114 of the battery cell 10 to provide an external connection to the anode or cathode electrodes.

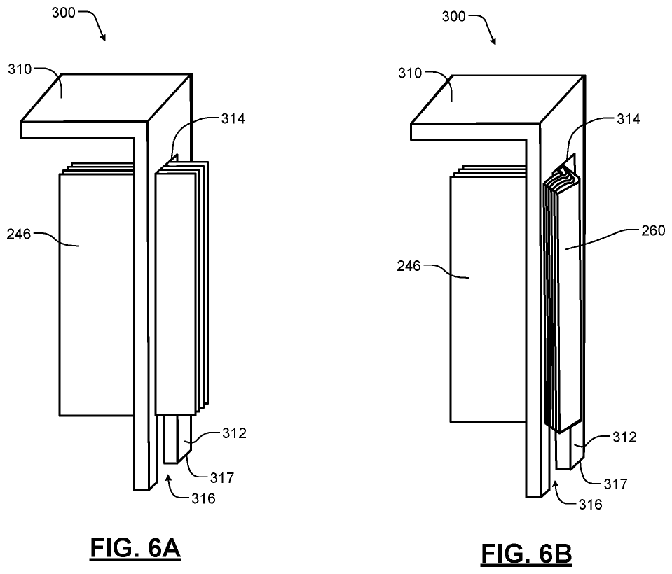

In FIGS. 5A to 5D, internal terminals including one or more slots can be used to improve the laser welding process. In FIG. 5A, an internal terminal 250 includes a first portion 252 and a second portion 254 extending from the first portion 252. In this example, the second portion 254 of the internal terminal 250 includes a slot 256 extending in a longitudinal direction. In some examples, the slot is a closed-ended slot. The slot 256 has a longitudinal length greater than or equal to a height of the external tabs 246 and a width greater than or equal to a thickness of the stack. Ends 260 of the external tabs 246 of the anode electrodes and/or cathode electrodes are inserted through the slot 256. In FIG. 5B, the ends 260 of the external tabs 246 are folded and laser welded by a laser 120 to a surface (e.g., an outer surface 251 and/or an edge surface 253) of the internal terminal 250. In other words, the laser 120 lap welds and/or edge welds the ends 260 of the external tabs 246 to the internal terminal 250.

In some examples, the ends 260 of the external tabs 246 are ultrasonically welded and/or trimmed prior to insertion through the slot 256. In other examples, the ends 260 of the external tabs 246 are not ultrasonically welded and/or trimmed prior to insertion through the slot 256.

In FIG. 5C, after insertion through the slot 256, the ends 260 of the external tabs 246 are separated into two groups (the groups may include the same or a different number of external tabs). The ends 260 of a first group of the external tabs 246 are folded in one direction at 260-1 (and laser welded to the outer surface 251 of the internal terminal 250). The ends 260 of a second group of the external tabs 246 are folded in the other direction at 260-2 (and laser welded to the outer surface 251 and/or the edge surface 253 of the internal terminal 250).

In FIG. 5D, an internal terminal 280 includes N slots 256-1, . . . , and 256-N, where N is an integer greater than one. In some examples, the N slots 256-1, . . . , and 256-N extend parallel to one another. Prior to insertion through the N slots 256-1, . . . , and 256-N, the ends 260 of the external tabs 246 are separated into N groups. The ends 260 of the N groups of the external tabs 246 are inserted through corresponding ones of the N slots 256-1, . . . , 256-N. All of the ends of the N groups can be folded in the same direction (e.g., either inward or outward in FIG. 5B), folded in different directions (e.g. adjacent pairs fold towards one another or adjacent pairs fold away from one another), and/or separated into first and second subgroups folded in opposite directions and laser welded to the outer surface 251 and/or the edge surface 253 of the internal terminal 280 as shown in FIG. 5C.

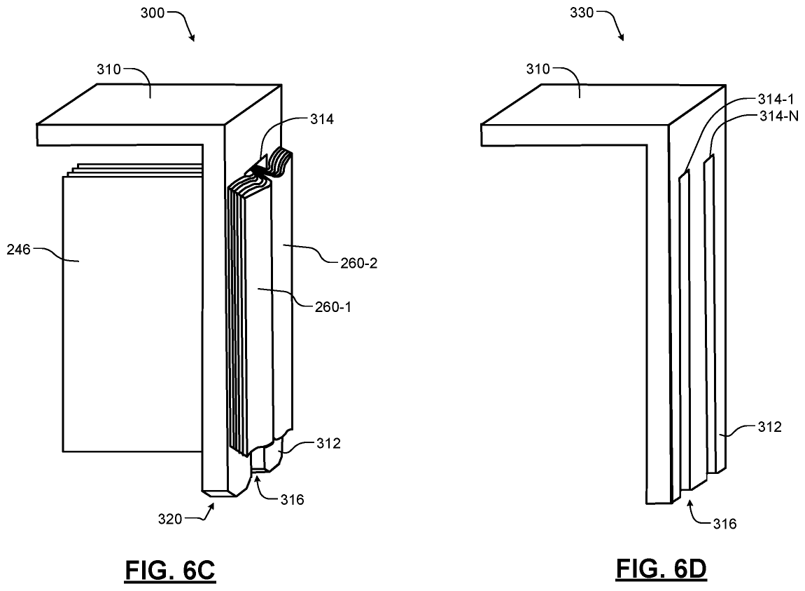

In FIGS. 6A to 6D, internal terminals including one or more open-ended slots can be used to improve the laser welding process. In FIG. 6A, an internal terminal 300 includes a first portion 310 and a second portion 312 extending from the first portion 310. In this example, the internal terminal 300 includes an open-ended slot 314 that extends to an edge 317 of the second portion 312 and includes an opening at 316. Ends 260 of the external tabs 246 of the anode electrodes and/or cathode electrodes are inserted into the slot 256 (e.g., from the side and/or through the opening 316). In FIG. 6B, the ends 260 of the external tabs 246 are folded and laser welded to a surface of the internal terminal 300.

In FIG. 6C, after insertion through the open-ended slot 314, the ends 260 of the external tabs 246 can be separated into two groups (with the same or different number of external terminals). The ends 260 of a first group of the external tabs 246 are folded in one direction and laser welded to a surface of the internal terminal 300. The ends 260 of a second group of the external tabs 246 are folded in the other direction and laser welded to a surface of the internal terminal 300. As can be appreciated, ends 320 adjacent to the openings 316 can be tapered to make insertion easier.

In FIG. 6D, an internal terminal 330 includes N slots 314-1, . . . , and 314-N, where N is an integer greater than one. Prior to insertion through the N slots 256-1, . . . , 256-N, the ends 260 of the external tabs 246 are separated into N groups. The ends 260 of the N groups of the external tabs 246 are inserted through corresponding ones of the N slots 314-1, . . . , and 314-N. All of the ends of the N groups can be folded in one direction and laser welded to a surface of the internal terminal 330 as in FIG. 6B. All of the ends of the N groups can be separated into first and second subgroups folded laterally (or transversely) in opposite directions and laser welded to a surface of the internal terminal 330 as in FIG. 6C.

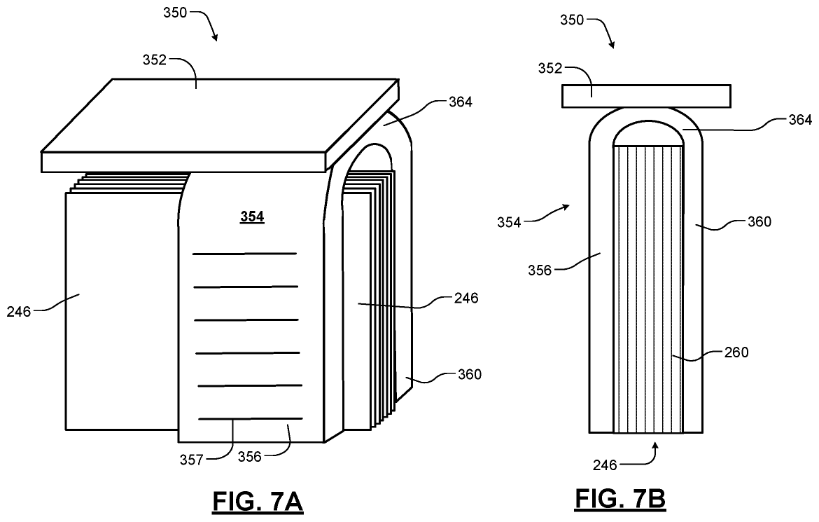

Referring now to FIGS. 7A and 7B, an internal terminal 350 includes a planar portion 352 and a second portion 354 including side walls 356 and 360 extending from a center portion 364. In some examples, the center portion 364 is arcuate or “U”-shaped. The ends 260 of the tabs 264 are arranged between the side walls 356. In some examples, the side walls 356 bias (e.g., apply force in an inward direction) the ends 260 of the external tabs 246 to improve electrical contact. In some examples, the side walls 356 are laser welded at 357 to the ends 260 of the external tabs 246.

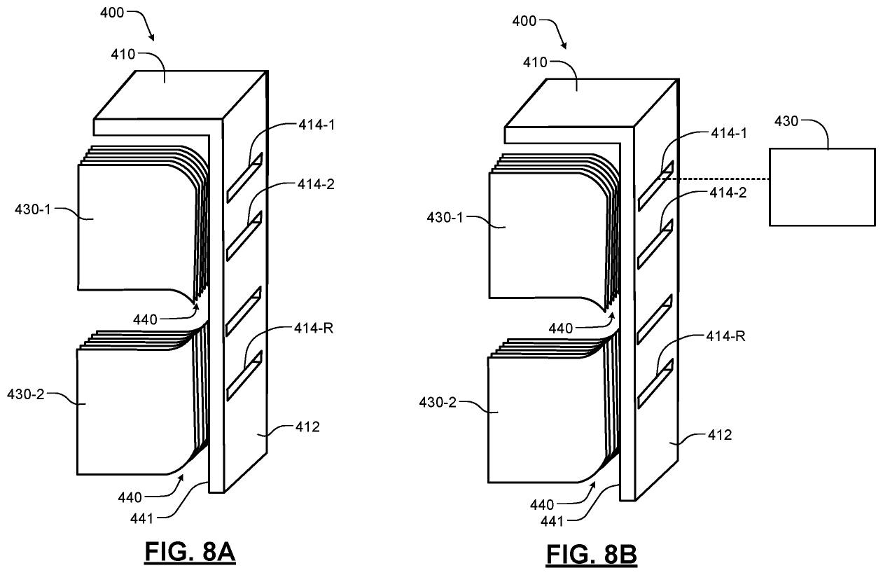

Referring now to FIGS. 8A and 8B, an internal terminal 400 includes a first portion 410 and a second portion 412 extending transversely relative to the first portion 410. In this example, the internal terminal 400 includes R slots 414-1, 414-2, . . . , and 414-R that extend between lateral edges of the second portion 412 (where R is an integer greater than zero). In some examples, the stack of battery cells include first external tabs 430-1 and second external tabs 430-2 that are connected to anode current collectors or cathode current collectors. In other words, each of the anode and cathode current collectors include two external tabs to provide a redundant connection which increases reliability. In some examples, first external tabs 430-1 and second external tabs 430-2 are bent in different lateral directions (the first external tabs 430-1 are bent in a direction out of the page and the second external tabs 430-2 are bent in a direction into the page).

In FIG. 8B, ends 440 of the first external tabs 430-1 and second external tabs 430-2 are positioned in contact with an inner surface 441 of the second portion 412, and laser welded to the inner surface 441 of the second portion 412 through one or more of the R slots 314-1, 314-2, . . . , and 314-R. In other words, the laser passes through the R slots 314-1, 314-2, . . . , and 314-R.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one; and
a first internal terminal including a first slot, wherein the external tabs of one of the C cathode electrodes and the A anode electrodes are inserted into the first slot,
wherein portions of the external tabs of the one of the C cathode electrodes and the A anode electrodes extend through the first slot, are folded and laser welded to a surface of the first internal terminal.

2. The battery cell of claim 1, further comprising a second internal terminal including a second slot to receive the external tabs of the other one of the C cathode electrodes and the A anode electrodes.

3. The battery cell of claim 2, wherein portions of the external tabs of the other one of the C cathode electrodes and the A anode electrodes extending through the second slot are folded and laser welded to a surface of the second internal terminal.

4. The battery cell of claim 1, wherein the first internal terminal includes N of the first slot, where N is an integer greater than one.

5. The battery cell of claim 4, wherein the external tabs of the one of the C cathode electrodes and the A anode electrodes are divided into N groups that are inserted through the N first slots, respectively, and are folded and laser welded to a surface of the first internal terminal.

6. The battery cell of claim 4, wherein the N first slots are open-ended.

7. The battery cell of claim 1, wherein the first slot is open-ended.

8. The battery cell of claim 1, wherein the external tabs of the one of the C cathode electrodes and the A anode electrodes are separated into a first group and a second group, folded in first and second directions, respectively, and laser welded to a surface of the first internal terminal on opposite sides of the first slot.

9. The battery cell of claim 1, wherein the first internal terminal is “L”-shaped and includes a first portion and a second portion extending transversely relative to the first portion.

10. The battery cell of claim 3, further comprising:
an enclosure;
a first external terminal in contact with the first internal terminal; and
a second external terminal in contact with the second internal terminal.

11. A battery cell, comprising:
a stack including:
C cathode electrodes each including a cathode current collector, a cathode active layer arranged on the cathode current collector, and an external tab extending from the cathode current collector;
A anode electrodes including an anode current collector, an anode active layer arranged on the anode current collector, and an external tab extending from the anode current collector; and
S separators, where C, A and S are integers greater than zero; and
a first internal terminal including R slots, where R is an integer greater than zero,
wherein the external tabs of the one of the C cathode electrodes and the A anode electrodes are folded and laser welded to an inner surface of the first internal terminal through at least one of the R slots of the first internal terminal.

12. The battery cell of claim 11 further comprising:
a second internal terminal including R slots,
wherein the external tabs of the other one of the C cathode electrodes and the A anode electrodes are folded and laser welded to an inner surface of the second internal terminal through at least one of the R slots of the second internal terminal.

13. The battery cell of claim 11, wherein:
R is greater than one; and
the external tabs of the one of the C cathode electrodes and the A anode electrodes are folded and laser welded to an inner surface of the first internal terminal through at least another one of the R slots of the first internal terminal.

14. The battery cell of claim 11, wherein the first internal terminal has an “L”-shape and includes a first portion and a second portion extending transversely relative to the first portion.

15. The battery cell of claim 11, wherein the external tabs of the one of the C cathode electrodes and the A anode electrodes include first external tabs and second external tabs that are folded in first and second directions and laser welded to the inner surface of the first internal terminal through the at least one of the R slots of the first internal terminal.

16. The battery cell of claim 12, further comprising:
an enclosure;
a first external terminal in contact with the first internal terminal; and
a second external terminal in contact with the second internal terminal.

17. A battery cell, comprising:
a stack including:
C cathode electrodes each including a cathode current collector, a cathode active layer arranged on the cathode current collector, and an external tab extending from the cathode current collector;
A anode electrodes including a cathode current collector, a cathode active layer arranged on the cathode current collector, and an external tab extending from the cathode current collector; and
S separators, where C, A and S are integers greater than one; and
a first internal terminal including:
a planar portion; and
a second portion including a center portion connected to the second portion and first and second side walls extending from the center portion;
wherein the external tabs of the one of the C cathode electrodes and the A anode electrodes pass through the first and second side walls of the first internal terminal and are laser welded to an inner surface of the first and second side walls of the first internal terminal.

18. The battery cell of claim 17, further comprising:
a second internal terminal including:
a planar portion; and
a second portion including a center portion and first and second sides extending from the center portion;
wherein the external tabs of the other one of the C cathode electrodes and the A anode electrodes pass through the first and second sides and are laser welded to an inner surface of the first and second side walls of the second internal terminal.

19. The battery cell of claim 18, further comprising:
an enclosure;
a first external terminal in contact with the planar portion of the first internal terminal; and
a second external terminal in contact with the planar portion of the second internal terminal.
